(19) United States
(12) Patent Application Publication
(10) Pub. No.: US 2026/0175389 A1
(43) Pub. Date: Jun. 25, 2026

(54) HANGER ACCESSORY WITH NOSEPIECE INSERT

(71) Applicant: MILWAUKEE ELECTRIC TOOL CORPORATION, Brookfield, WI (US)

(72) Inventors: Connor D. Sreenan, Wauwatosa, WI (US); Rosalie C. Phillips, Milwaukee, WI (US); Ivan N. Zozulya, Waukesha, WI (US)

(21) Appl. No.: 19/425,083

(22) Filed: Dec. 18, 2025

Related U.S. Application Data
(60) Provisional application No. 63/736,778, filed on Dec. 20, 2024.
(60) Provisional application No. 63/810,202, filed on May 22, 2025.

(51) Int. Cl. B25C 7/00; B25C 1/00; B25C 1/04; B25C 1/06

(52) U.S. Cl. CPC B25C 7/00; B25C 1/008; B25C 1/047; B25C 1/06

(57) ABSTRACT

A hanger accessory, for use with a powered fastener driver including a nosepiece from which fasteners are discharged, includes a bracket configured to be mounted to a work surface and an insert coupled to the bracket. The insert includes a base defining a recess having a bottom surface and an adjacent side wall, and a retaining member extending from the bottom surface of the recess and spaced apart from the side wall. The retaining member has an aperture extending therethrough and defines an outer perimeter. The recess is configured to receive the nosepiece such that the outer perimeter of the retaining member is engaged by the nosepiece with an interference fit and with a distal end of the nosepiece contacting the bottom surface of the recess and an exterior of the nosepiece being spaced inward from the side wall.

### CROSS-REFERENCE TO RELATED APPLICATIONS

This application claims priority to U.S. Provisional Ser. No. 63/810,202 filed on May 22, 2025, and to U.S. Provisional Ser. No. 63/736,778 filed on Dec. 20, 2024, the entire contents of each of which are incorporated herein by reference.

### FIELD OF THE INVENTION

The present invention relates to hanger accessories for use with a powered fastener driver, and more particularly to hanger accessories with a nosepiece insert to be received by a nosepiece of the powered fastener driver.

### SUMMARY OF THE INVENTION

In some aspects, the techniques described herein relate to a hanger accessory for use with a powered fastener driver, the powered fastener driver including a nosepiece from which fasteners are discharged, the hanger accessory including: a bracket configured to be mounted to a work surface; and an insert coupled to the bracket, the insert including a base defining a recess having a bottom surface and an adjacent side wall, and a retaining member extending from the bottom surface of the recess and spaced apart from the side wall, the retaining member having an aperture extending therethrough and defining an outer perimeter, wherein the recess is configured to receive the nosepiece such that the outer perimeter of the retaining member is engaged by the nosepiece with an interference fit and with a distal end of the nosepiece contacting the bottom surface of the recess and an exterior of the nosepiece being spaced inward from the side wall.

In some aspects, the techniques described herein relate to a hanger accessory for use with a powered fastener driver, the powered fastener driver including a nosepiece from which fasteners are discharged, the hanger accessory including: a bracket configured to be mounted to a work surface; and an insert supported by the bracket, the insert including a base defining a recess defining a bottom surface and an adjacent side wall; and a retaining member extending from the bottom surface of the recess and spaced apart from the side wall, the retaining member having an aperture extending therethrough, the retaining member having a distal end, a first portion extending from the bottom surface of the recess toward the distal end and defining an outer perimeter, a second portion extending from the second portion to the distal end, the second portion extending inwardly from the first portion at an angle, wherein the first portion has a height that is less than a height of the side wall, wherein the recess is configured to receive the nosepiece such that the outer perimeter of the retaining member is engaged within the nosepiece with an interference fit.

In some aspects, the techniques described herein relate to a hanger accessory for use with a powered fastener driver, the powered fastener driver including a nosepiece from which fasteners are discharged, the hanger accessory including: a bracket configured to be mounted to a work surface; and an insert supported by the bracket, the insert including a base defining a recess defining a bottom surface and an adjacent side wall; and a retaining member extending from the bottom surface of the recess and spaced apart from the side wall of the recess, the retaining member including a shaft extending from the bottom surface and having a distal end opposite the bottom surface and an aperture extending along a length of the shaft, and a plurality of projections extending tangentially from the shaft, each of the plurality of projections extending between the bottom surface of the recess to the distal end, wherein a first portion of each of plurality of projections extends from the bottom surface of the recess toward the distal end and a second portion of each of the plurality of projections is extending inwardly relative to the corresponding first portion, wherein the recess is configured to receive the nosepiece such that the first portions of at least a subset of the plurality of projections are collectively engaged by the nosepiece with an interference fit and with a distal end of the nosepiece contacting the bottom surface of the recess and an exterior of the nosepiece being spaced inward from the side wall.

In some aspects, the techniques described herein relate to a hanger accessory for use with a powered fastener driver, the powered fastener driver including a nosepiece from which fasteners are discharged, the hanger accessory including: a bracket configured to be mounted to a work surface, the bracket including a recess having a bottom surface and an adjacent side wall, and a retaining member extending from the bottom surface of the recess and spaced apart from the side wall, the retaining member having an aperture extending therethrough and defining an outer perimeter, wherein the recess is configured to receive the nosepiece such that the outer perimeter of the retaining member is engaged by the nosepiece with an interference fit and with a distal end of the nosepiece contacting the bottom surface of the recess and an exterior of the nosepiece being spaced inward from the side wall.

Other features and aspects of the invention will become apparent by consideration of the following detailed description and accompanying drawings.

### BRIEF DESCRIPTION OF THE DRAWINGS

FIG. 1 is a side view of a powered fastener driver including a nosepiece.

FIG. 2 is a cross-sectional view of the powered fastener driver of FIG. 1.

FIG. 3 is a perspective view of a nosepiece of the powered fastener driver of FIG. 1.

FIG. 4 is top perspective view of a hanger accessory including an insert according to one embodiment of the invention.

FIG. 5 is bottom perspective view of the hanger accessory and insert of FIG. 4.

FIG. 6 is a top view of the insert of FIG. 4.

FIG. 7 is a detailed top view of the insert of FIG. 4 received within the nosepiece of FIG. 3.

FIG. 8A is a cross-sectional view of the insert of FIG. 4 along section 8A-8A in FIG. 6.

FIG. 8B is another cross-sectional view of the insert of FIG. 4 along section 8B-8B in FIG. 6.

FIG. 9A is a perspective view of an insert, according to another embodiment, for use with the hanger accessory of FIG. 4.

FIG. 9B is a cross-sectional view of the insert of FIG. 9A received within the nosepiece of the powered fastener driver of FIG. 1.

FIG. 10 is a perspective view of an insert, according to another embodiment, for use with the hanger accessory of FIG. 4.

FIG. 11 is a perspective view of an insert, according to another embodiment, for use with the hanger accessory of FIG. 4.

FIG. 12 is a perspective view of an insert, according to another embodiment, for use with the hanger accessory of FIG. 4.

FIG. 13 is a side view of the insert of FIG. 12.

FIG. 14 is a perspective view of an insert, according to another embodiment, for use with the hanger accessory of FIG. 4.

FIG. 15 is a cross-sectional view of the insert of FIG. 14 along the line 15-15 of FIG. 14.

FIG. 16 is a perspective view of an insert, according to another embodiment, for use with the hanger accessory of FIG. 4.

FIG. 17 is a cross-sectional view of the insert of FIG. 14 along the line 17-17 of FIG. 16.

FIG. 18 is a cross-sectional view of the insert of FIG. 14 along the line 18-18 of FIG. 17.

FIG. 19 is a cross-sectional view of the insert of FIG. 14 along the line 19-19 of FIG. 17.

FIG. 20 is a perspective view of an insert, according to another embodiment, for use with the hanger accessory of FIG. 4.

FIG. 21 is a cross-sectional view of the insert of FIG. 20 along the line 21-21 of FIG. 20.

FIG. 22 is a perspective view of an insert, according to another embodiment, for use with the hanger accessory of FIG. 4.

FIG. 23 is a perspective view of an insert, according to another embodiment, for use with the hanger accessory of FIG. 4.

FIG. 24 is a perspective view of a bracket including an integrally formed insert.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

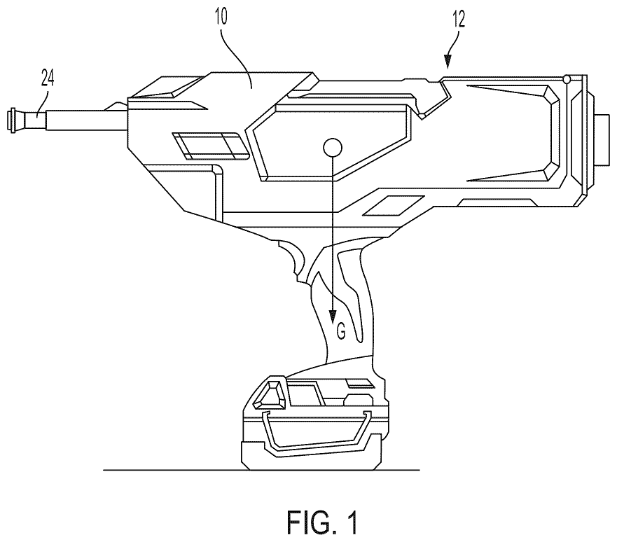

FIG. 1 illustrates a powered fastener driver 10 capable of discharging fasteners (e.g., nails) into a work surface (e.g., a wall formed from concrete, steel, solid masonry, steel, etc.) to secure devices or structures (electrical installation, cables, framing, etc.) to the work surface. In some embodiments, the powered fastener driver 10 may be configured as a single-shot powered fastener driver capable of discharging individual fasteners, one at a time, as they are manually loaded into the fastener driver after each driving cycle. In other embodiments, the powered fastener driver 10 may be configured as a multi-shot powered fastener driver including a magazine holding a collated fastener strip, which does not require the user to manually reload the fastener driver after each driving cycle.

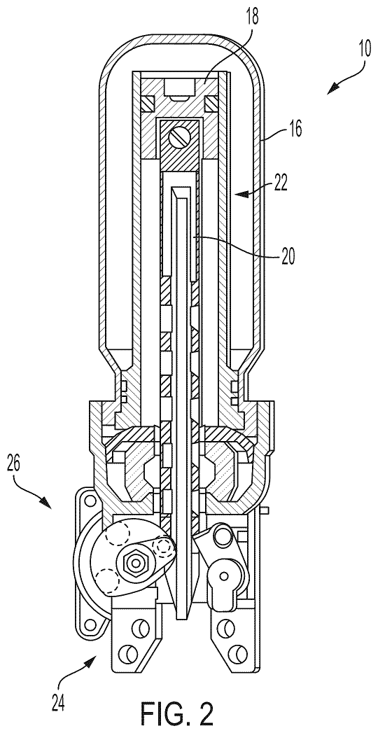

In the illustrated embodiment, the powered fastener driver 10 is a gas-spring powered fastener driver 10. The powered fastener driver 10 includes a housing 12 (FIG. 2) containing therein a motor (e.g., a brushless direct current electric motor) that supplies a motive force to operate the powered fastener driver 10. The housing 12 further contains a cylinder 16, a drive piston 18 located within the cylinder 16 for reciprocal movement therein, and a drive blade 20 attached to the drive piston 18. The powered fastener driver 10 also includes a gas spring 22 (i.e., a fixed quantity of compressed gas, such as Nitrogen) within the cylinder 16 which, during a fastener driving operation, expands within the cylinder 16 to displace the drive piston 18 and the drive blade 20 toward the work surface to discharge the fastener out a nosepiece 24 and into the work surface. The powered fastener driver 10 also includes a lifter mechanism 26 coupled between the motor and the drive piston 18. The lifter mechanism 26 returns the drive piston 18 and drive blade 20 toward a top-dead-center position within the cylinder 16, which compresses the gas spring 22 for a subsequent fastener driving operation.

The nosepiece 24 retracts in response to contact with the work surface and further functions as a safety for the powered fastener driver 10. In the illustrated embodiment, the nosepiece 24 is configured as a barrel that is sized to discharge the fastener therethrough. As shown in FIG. 3, an end 30 of the nosepiece 24 includes a positive trace or protrusion 32. In the illustrated example, the end 30 of the nosepiece 24 includes a circular protrusion 32.

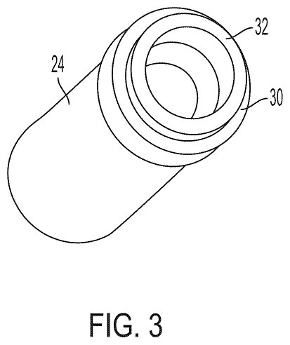

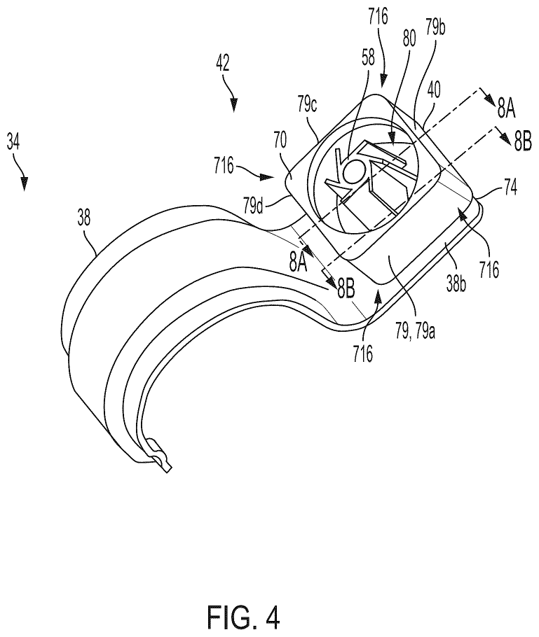

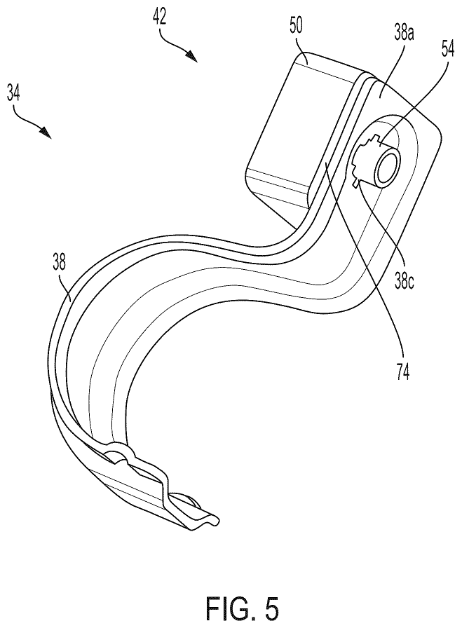

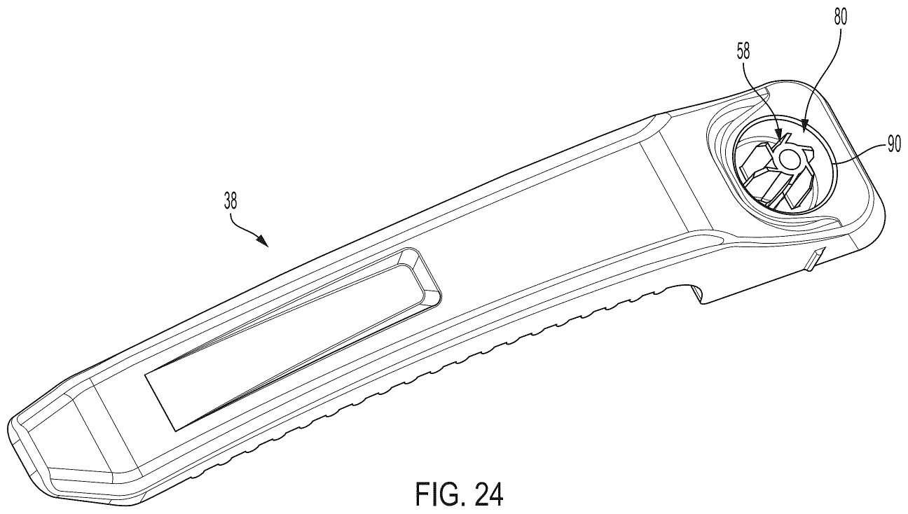

FIGS. 4-5 illustrate a hanger accessory 34 for use with the powered fastener driver 10. The hanger accessory 34 is secured to the work surface. The hanger accessory 34 includes a bracket 38 and a plastic insert 42. The bracket 38 is secured to the work surface via the powered fastener driver 10. In particular, the bracket 38 defines a mounting surface 38a and an insert support surface 38b. An aperture 38c extends between the mounting surface 38a and the insert support surface 38b, as shown. The plastic insert 42 is supported by the bracket 38 and is configured to be received within the nosepiece 24 to retain the hanger accessory 34 to the nosepiece 24 prior to being secured to the work surface (FIG. 10). The insert 42 may have a variety of configurations, as shown herein. Therefore, like structure will be identified with like terms and reference numerals only the differences discussed herein. Also, in the illustrated embodiment, the bracket 38 and the insert 42 are formed separately and then coupled to one another. In other embodiments, the bracket 38 may be integrally formed with the insert 42, as shown in FIG. 24.

As shown in FIGS. 4-5, the insert 42 includes a base 50, a connecting member 54 (FIG. 5) supported by and extending from the base 50, and a retaining member 58 supported by the base 50.

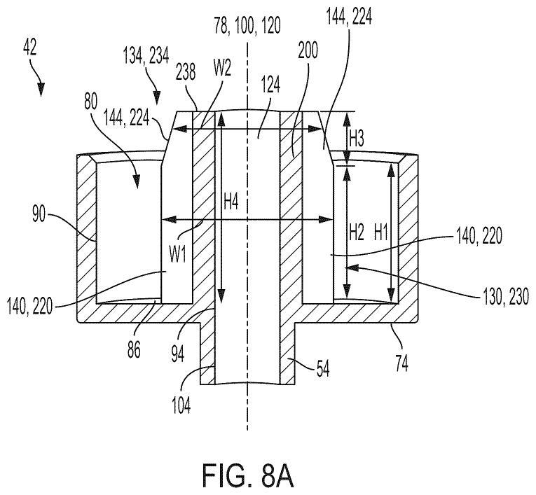

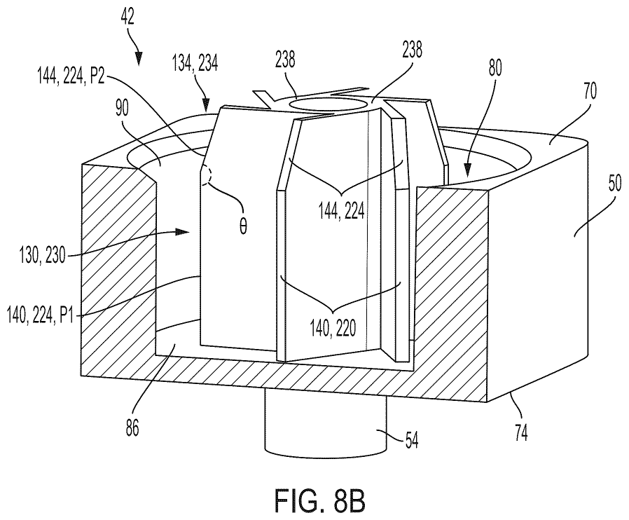

The base 50 includes a first surface 70 and a second surface 74 opposite the first surface 70. The base 50 defines a longitudinal axis 78 (FIG. 8A) extending between the first surface 70 and the second surface 74. The base 50 defines an outer wall 79 extending between the first surface 70 and the second surface 74. A recess 80 is defined in the base 50, and specifically, the first surface 70 of the base 50. The recess 80 includes a bottom surface 86 and an adjacent side wall 90 surrounding the bottom surface 86. The bottom surface 86 is generally parallel to the first surface 70. An aperture 94 (FIG. 8A) extends through the base 50 along the longitudinal axis 78. One end of the aperture 94 is extends through the bottom surface 86 and the opposite end of the aperture 94 extends through the second surface 74.

In the illustrated embodiment, the base 50 has a perimeter that is a first shape (e.g., square) and the recess 80, defined by the side wall 90, has a second shape (e.g., circular) that is different from the first shape. In other embodiments, the first perimeter and second perimeter may have the same shape. Moreover, in the embodiment of FIGS. 4-5, the outer wall 79 includes four sides 79a-79d. The adjacent sides 79a-79d are coupled to one another to define corners 716.

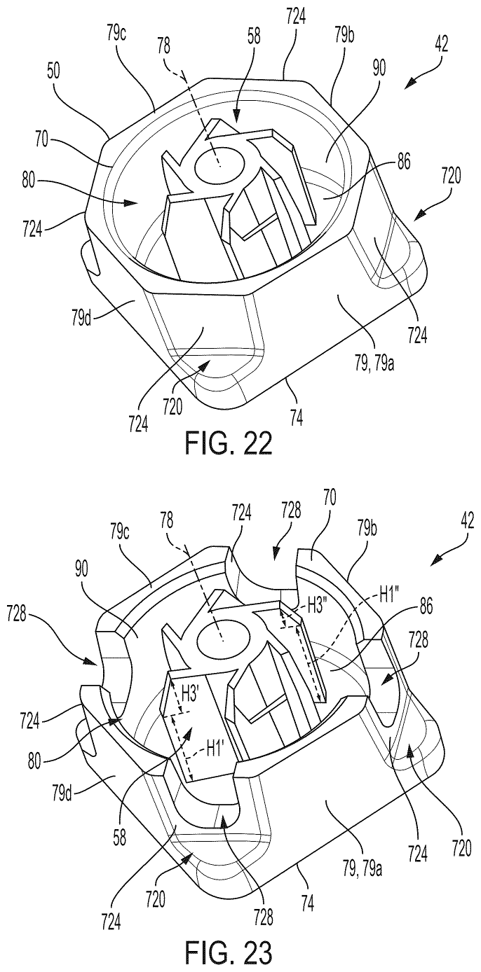

In the embodiment of FIG. 22, the base 50 has an alternative configuration. As shown, the outer wall 79 includes a plurality of notches 720. In the illustrated embodiment, one of the notches 720 is formed in each corner 716, such that there are four notches 720. In other embodiments, the notches 720 may be positioned elsewhere and/or there may be greater or fewer notches 720. In the illustrated embodiment, the notches 720 extend from the first surface 70 toward the second surface 74 and are generally parallel to the longitudinal axis 78. As shown, the notches 720 extend partially from the first surface 70 to the second surface 74. Thus, the notches 720 each define a notch surface 724 that is indented relative the outer wall 79. Each of the notch surfaces 724 define a plane that is generally parallel to the longitudinal axis 78. In the illustrated embodiment, each of the notch surfaces 724 extend between adjacent sides 79a-79d of the outer wall 79. As shown, the notch surfaces 724 are positioned at oblique angles relative to the respective sides 79a-79b. As shown, the notch surfaces 724 are positioned at obtuse angles relative to the respective sides 79a-79b. The notches 720 reduce the mass of the base 50 by greater than 10%. In the illustrated embodiment, the notches reduce the mass of the base 50 by 14%, for example.

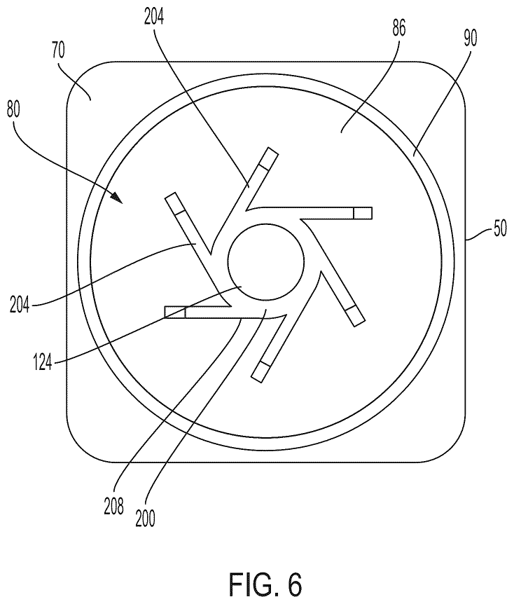

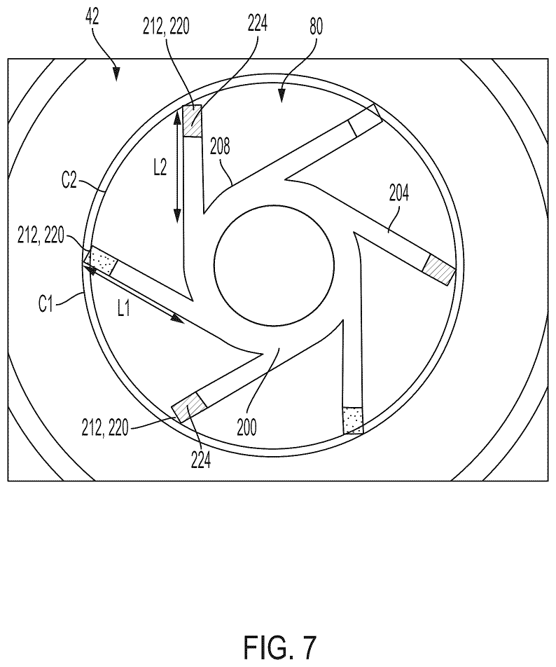

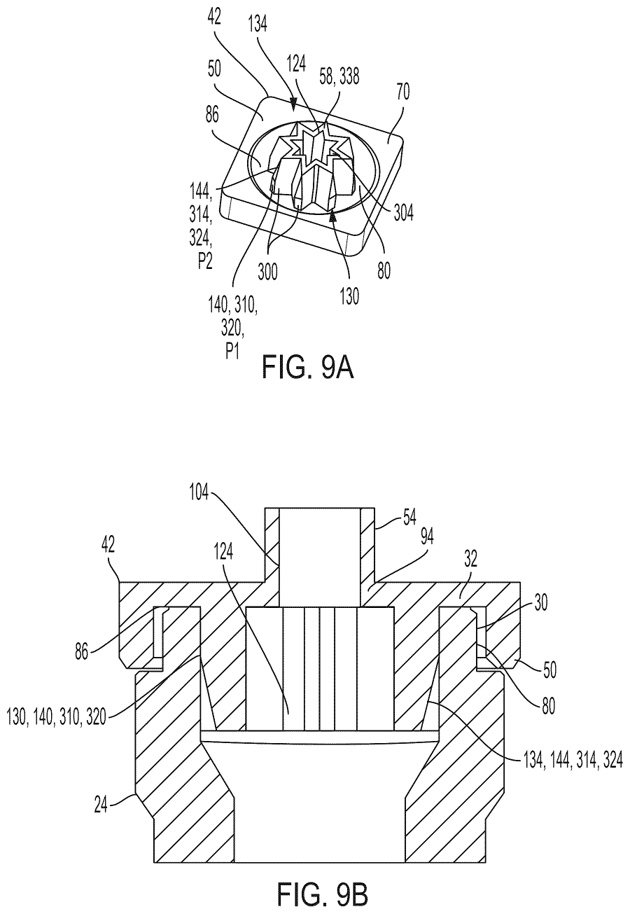

In the embodiment of FIG. 23, the base 50 has yet another alternative configuration. As shown, the base 50 includes the notches 720, discussed above with respect to FIG. 22, and further includes a plurality of grooves 728 extending from the first surface 70 towards the second surface 74. Each of the grooves also extends between the side wall 90 to the notch surface 724. In the illustrated embodiment, the grooves 728 are each U-shaped, although they may have other shapes in other embodiments. The notches 720 and the grooves 728 reduce the mass of the base 50 by at least 20%. In the illustrated embodiment, the notches 720 and grooves 728 reduce the mass of the base by 20%, for example. Although the configuration of the base 50 are shown relative to the embodiment of FIGS. 4-8B, the base 50 of embodiments of FIGS. 9A-21 may also include the configurations of FIGS. 22 and 23.

In each of the embodiments, the connecting member 54 extends from the second surface 74. An axis 100 (FIG. 8A) extending through the connecting member 54 is aligned with (e.g., coextensive with) the longitudinal axis 78 of the base 50. The connecting member 54 defines an aperture 104 extending therethrough along the axis 100. The aperture 104 in the connecting member 54 is in communication with and aligned with the aperture 94 in the base 50. The connecting member 54 extends through the aperture 38c in the bracket 38, while the second surface 74 of the base 50 is positioned on the insert support surface 38b of the bracket 38.

In each of the embodiments, the retaining member 58 is coupled to and extends from the base 50. As shown, the retaining member 58 is positioned within the recess 80 and extends from the bottom surface 86. An axis 120 (FIG. 8A) extending through the retaining member 58 is aligned with (e.g., coextensive with) the longitudinal axis 78 of the base 50. The retaining member 58 is spaced apart from the side wall 90 by a first clearance or gap. The retaining member 58 defines an aperture 124 extending therethrough along the axis 120. The aperture 124 in the retaining member 58 is in communication with and aligned with the apertures 94, 104 in the base 50 and the connecting member 54. The retaining member 58 also has a first portion 130 coupled to and extending from the bottom surface 86 and a second portion 134 extending from the first portion 130.

As shown in FIG. 8A, the first portion 130 defines a perimeter of the retaining member 58 and has a height H1 that is less than a height H2 of the wall 90 of the recess 80. Moreover, a height H3 of the second portion 134 is generally less than the height H1 of the first portion 130. The perimeter has a first dimension (e.g., width W1). The second portion 134 has a second dimension that is smaller than the first dimension (e.g., width W2). The first width W1 is generally uniform along a height H4 of the retaining member 58, whereas the second width W2 decreases along the height H4 of the retaining member 58. In the illustrated embodiments, the first portion 130 defines one or more outermost edges 140 and the second portion 134 defines one or more outermost edges 144. Each of the outermost edges 140 of the first portion 130 extend in a first plane P1 (FIG. 8B) that is generally perpendicular to the bottom surface 86. Each of the outermost edges 144 of the second portion 134 extend in a second plane P2 (FIG. 8B) that is inwardly angled (e.g., angled towards the axis 120) relative to the first plane P1 of the corresponding outermost edge 140 of the first portion 130, as will be discussed in greater detail below. In other words, the outermost edges 144 of the second portion 134 are chamfered relative to the corresponding outermost edges 140 of the first portion 130.

In the illustrated embodiments, the angle θ of the second plane P2 relative to the corresponding first plane P1 is approximately 163 degrees. The term “approximately” as used herein means plus or minus one degree. In other embodiments, the angle θ of the second plane P2 relative to the corresponding first plane P2 is less than approximately 180 degrees. In other embodiments, the angle θ of the second plane P2 relative to the first plane P1 is greater than approximately 150 degrees. In other embodiments, the angle θ of the second plane P2 relative to the corresponding first plane P1 is between approximately 120 degrees and approximately 180 degrees. In other embodiments, the angle θ of the second plane P2 relative to the corresponding first plane P1 is between approximately 130 degrees and approximately 170 degrees. In other embodiments, the angle θ of the second plane P2 relative to the corresponding first plane P1 is between approximately 140 degrees and approximately 165 degrees

As shown in FIG. 9B, the first portion 130 is configured to engage an inner surface of the nosepiece 24, while the protrusion 32 of the nosepiece 24 is configured to be received within the recess 80 between the retaining member 58 and the side wall 90. The first portion 130 is configured to create an interference fit with the inner surface of the nosepiece 24. As shown in FIG. 9B, when the nosepiece 24 receives the retaining member 58, each of the outermost edges 140 of the first portion 130 engages the inner surface of the nosepiece 24 and a second clearance or gap is defined between the inner surface of the nosepiece 24 and each of the outermost edges 144 of the second portion 134. Additionally, the apertures 94, 104, 124 of the base 50, the connecting member 54, and the retaining member 58 collectively define a pathway that is aligned with the conduit of the nosepiece 24 and configured to receive a fastener and guide the fastener into the work surface. As the fastener is driven into the work surface, the head of the fastener engages the distal end of the retaining member 58 and retaining member 58 moves with the fastener as the fastener is driven into the work surface. Additionally, once driven into the work surface, the insert 42 is coupled between the bracket 38, coupled to the work surface, and the head of the fastener. In the illustrated embodiment, the retaining member 58 has a crushing performance in which the retaining member 58 elastically deforms such that it is not destroyed by the force of the fastener, but instead retains its general shape even after the bracket 38 is coupled to the work surface.

With respect to FIGS. 4-8B, the retaining member 58 of the insert 42 includes a shaft 200 and a plurality of projections 204. The shaft 200 is coupled to and extends from the bottom surface 86. The shaft 200 defines the aperture 124 and includes an outer peripheral surface 208. The shaft 200 is generally cylindrical and defines a generally cylindrical aperture 124, as well. Each of the projections 204 extends outwardly from the shaft 200. As shown, each of the projections 204 extends tangentially from the outer peripheral surface 208 of the shaft 200. Each of the projections 204 has a distal end 212 that is spaced apart from the shaft 200. The distal end 212 defines a first face 220 and a second face 224 that is inwardly angled relative to the first face 220. Each of the projections 204 is separated from the adjacent projections 204 by a third clearance or gap.

As shown, each of the projections 204 includes a first portion 230 defined in part by the first face 220 and a second portion 234 defined in part by the second face 224. The first portion 230 of each of the projections 204 extends from the bottom surface 86 toward a distal end 238 of the shaft 200. The second portion 234 of each of the projections 204 extends from the first portion 230 to the distal end 238 of the shaft 200. As shown, collectively, the first portions 230 of the projections 204 define the first portion 130 of the retaining member 58, while, collectively, the second portions 234 of the projections 204 define the second portion 134 of the retaining member 58. Additionally, each of the first faces 220 of the projections 204 extends in a first plane P1 that is perpendicular to the bottom surface 86. Each of the second faces 224 of the projections 204 extends in a second plane P2 that is inwardly angled relative to the corresponding first face 220. The second portions 234 each define a chamfered edge, and collectively, the second portions 234 define a chamfered edge of the retaining member 58.

In the embodiment of FIGS. 4-8B, the first portions 230 of the projections 204 have the same height H1 and the second portions 234 of the projections 204 have the same height H3, which is less than the height H1, as noted above. In some embodiments, such as those of FIGS. 22 and 23, the first portion 230 of a first subset of each of the projections 204 may have a first height H1′, while the corresponding second portion 234 may have a second height H1′. Similarly, the first portion 230 of a second subset of each of the projections 204 may have a third height H3′, while the corresponding second portion 234 may have a fourth height H3″. Although only shown in FIG. 22, in the embodiments of FIGS. 22 and 23, the first height H1′ and the third height H1″ are different, and the second height H3′ and the fourth height H3″ are different. For example, the first height H1′ is less than the third height H1″, and the second height H3′ is greater than the fourth height H3″. The projections of the first subset alternate with the projection of the second subset.

In the illustrated embodiment, the projections 204 include a first set of projections 204 including a first length L1 between the shaft 200 and the distal end 238 thereof and a second set of projections 204 including a second, shorter length L2 between the shaft 200 and the distal end 238 thereof. Accordingly, the first set of projections 204 define a first maximum radius and the second set of projections 204 define a second maximum radius, which is smaller than the first maximum radius. The first set of projections 204 alternate with the second set of projections 204 about the perimeter of the shaft 200. Collectively, the first set of projections 204 defines the perimeter of the first portion 130. The perimeter thus is defined by the first maximum radius of the first set of projections 204 and has a first circumference C1. The second set of projections 204 collectively define a second circumference C2 (determined by the second maximum radius), which is smaller than the first circumference C1. Accordingly, only the first set of projections 204 are configured to engage with (e.g., create an interference fit with) the inner surface of the nosepiece 24, while the second set of projections 204 are spaced apart from the inner surface of the nosepiece 24 but give support and maintain crushing performance. In other embodiments, each of the projections 204 may have the same length and define the same maximum radius such that each of the projections 204 defines the perimeter of the first portion 130 and engages with (e.g., create an interference fit with) the inner surface of the nosepiece 24. In other embodiments, a subset of the projections 204 may have the same length and define the same maximum radius such that the subset of the projections 204 defines the perimeter of the first portion 130 and engages with (e.g., create an interference fit with) the inner surface of the nosepiece 24. In such embodiments one or more additional subsets of projections may have the different lengths and define a different, smaller maximum radius. That is, subsets of projections may have other configurations than the first subset of projections 204.

In the embodiment of FIGS. 4-8B there are six projections 204 although there may be more or fewer projections 204 in other embodiments. Additionally, there are three projections 204 in the first set and three projections 204 in the second set, although in other embodiments, there may be more or fewer projections 204 in each set. Additionally, there are the same number of projections 204 in the first set as the second set, in the illustrated embodiment, but in other embodiments, there may be more or fewer projections 204 in the second set than the first set.

In the embodiment of FIGS. 9A-10, the retaining member 58 includes a plurality of V-shaped projections 300, which are interconnected to one another. The V-shaped projections 300 are spaced apart from one another by a third clearance of gap. Each of the V-shaped projections 300 define a portion of a wall of the retaining member 58 and define a groove 304 that forms portion of the aperture 124. As shown, each of the V-shaped projections 300 each includes a first leg and a second leg connected to the first leg. The intersection of the first leg with the second leg defines a first face 310 and a second face 314 that is inwardly angled relative to the first face 310. Collectively, the V-shaped projections 300 form the shape of a star. Thus, the cross-sectional shape of the retaining member 58 is a star, where the cross-section is taken in a plane P4 (FIG. 10) perpendicular to the axis 120 of the retaining member 58. Accordingly, the aperture 124 is also star-shaped. The retaining member 58 surrounds the aperture 124 in the base 50. In the illustrated embodiment, there are eight V-shaped projections 300, but there may be greater or fewer than eight projections 300 in other embodiments. In the embodiment of FIGS. 9A-9B there are eight V-shaped projections 300, while in the embodiment of FIG. 10, there are four V-shaped projections 300.

As shown, each of the V-shaped projections 300 includes a first portion 320 defined in part by the first face 310 and a second portion 324 defined in part by the second face 314. The first portion 320 of each of the V-shaped projections 300 extends from the bottom surface 86 toward a distal end 338 of the retaining member 58. The second portion 324 of each of the V-shaped projections 300 extends from the first portion 320 to the distal end 338 of the retaining member 58. As shown, collectively, the first portions 320 of the V-shaped projections 300 define the first portion 130 of the retaining member 58, while, collectively, the second portions 324 of the V-shaped projections define the second portion 134 of the retaining member 58. Additionally, each of the first faces 310 of the V-shaped projections 300 extends in a first plane P1 that is perpendicular to the bottom surface 86. Each of the second faces 314 of the V-shaped projections 300 extends in a second plane P1 that is inwardly angled relative to the first face 310. The second portions 324 are generally flat or planar in the illustrated embodiment and therefore, each define a chamfered edge. Collectively, the second portions 324 thus define a chamfered edge of the retaining member 58. In other embodiments, the second portions 324 may be generally curved or arcuate and therefore, each define a radiused edge. Collectively, the second portions 324 may thus define a curved edge of the retaining member 58 in other embodiments.

Although the projections 300 are V-shaped in FIGS. 9-10, in other embodiments, the projections 300 may have other shapes in other embodiments. For example, in some embodiments, the projections 300 may be semi-circular, cuboidal, polygonal, etc.

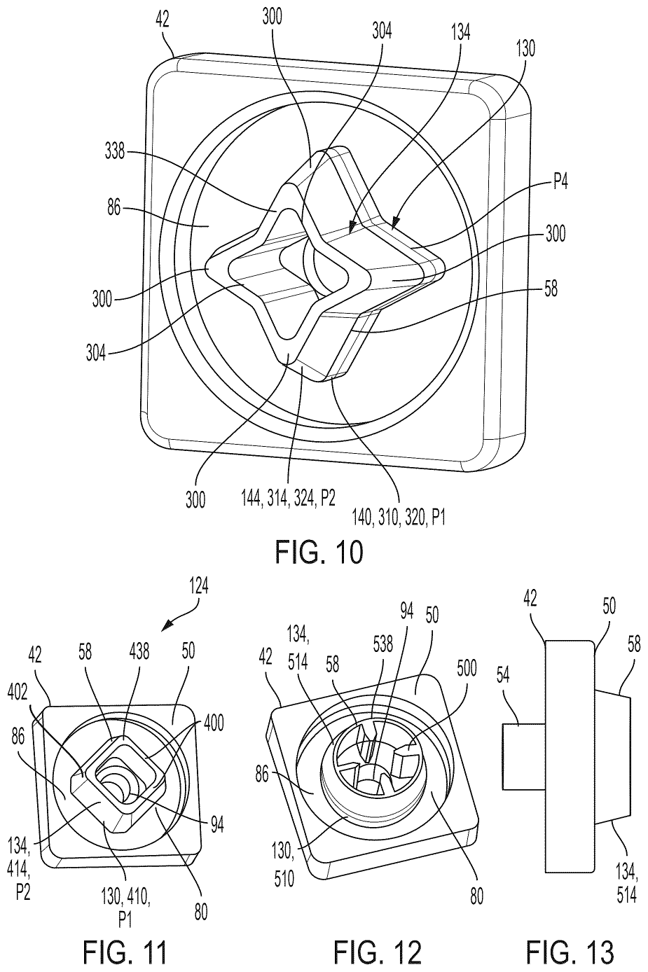

In the embodiment of FIGS. 11 and 14-18, the retaining member 58 is generally polygonal and therefore has a polygonal cross-section. As shown, the retaining member 58 includes a plurality of sides 400 that are coupled to one another. In the illustrated embodiment, the retaining member 58 has four sides 400 and has a generally square shape. In other embodiments, the retaining member 58 may have three or more sides 400. As shown, the retaining member 58 surrounds the aperture 94 in the base 50.

As shown in FIG. 11, each side 400 and the corners 402 adjoining adjacent sides 400 each include a first portion 410 and a second portion 414. The first portion 410 of each of the sides 400 and corners 402 extends from the bottom surface 86 toward a distal end 438 of the retaining member 58. The second portion 414 of each of the sides 400 and corners 402 extends from the first portion 410 to the distal end 438 of the retaining member 58. As shown, collectively, the first portions 410 of the sides 400 and corners 402 define the first portion 130 of the retaining member 58, while, collectively, the second portions 414 of the sides 400 and corners 402 define the second portion 134 of the retaining member 58. Additionally, each of the first portions 410 of the sides 400 and corners 402 extends in a first plane P1 that is perpendicular to the bottom surface 86. Each of the second portions 414 of the sides 400 and corners 402 extends in a second plane P2 that is inwardly angled relative to the first portion 410. The second portions 414 are generally flat or planar in the illustrated embodiment and therefore, each define a chamfered edge. Collectively, the second portions 414 thus define a chamfered edge of the retaining member 58. In other embodiments, the second portions 414 may be generally curved or arcuate and therefore, each define a radiused edge. Collectively, the second portions 414 may thus define a curved edge of the retaining member 58 in other embodiments.

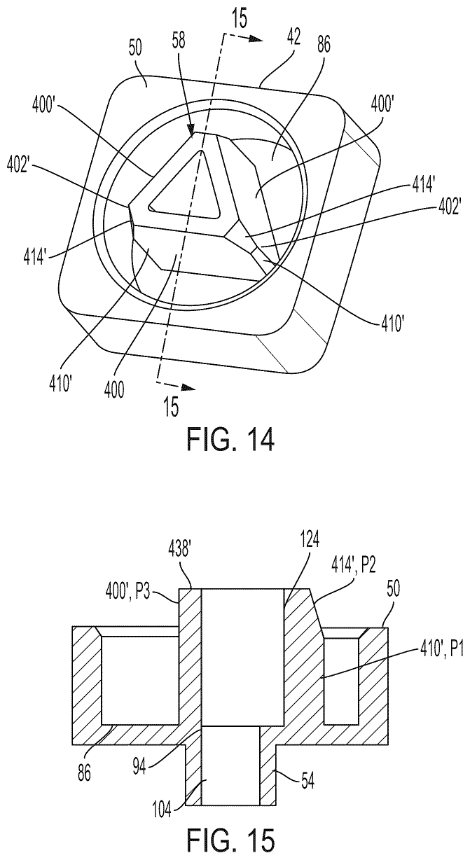

As shown in FIGS. 14-15, the retaining member 58 has three sides 400′ and has a generally triangular shape. The retaining member 58 surrounds the aperture 94 in the base 50. In the embodiment of FIGS. 14 and 15, each of the sides 400′ do not include separate portions. Instead, each of the sides 400′ extends from the bottom surface 86 toward the distal end 438′ of the retaining member 58 in a single plane P3. Each of the corners 402′ adjoining adjacent sides 400′ include a first portion 410′ and a second portion 414′. The first portion 410 of each of the corners 402′ extends from the bottom surface 86 toward a distal end 438′ of the retaining member 58. The second portion 414′ of each of the corners 402′ extends from the first portion 410′ to the distal end 438′ of the retaining member 58. As shown, collectively, the first portions 410 of the corners 402′ define the first portion 130 of the retaining member 58, while, collectively, the second portions 414 of the corners 402′ define the second portion 134 of the retaining member 58. Additionally, each of the first portions 410′ of the corners 402′ extends in a first plane P1 that is perpendicular to the bottom surface 86. Each of the second portions 414′ of the corners 402′ extends in a second plane P2 that is inwardly angled relative to the first portion 410′. The second portions 414′ are generally flat or planar in the illustrated embodiment and therefore, each define a chamfered edge. Collectively, the second portions 414′ thus define a chamfered edge of the retaining member 58. In other embodiments, the second portions 414′ may be generally curved or arcuate and therefore, each define a radiused edge. Collectively, the second portions 414′ may thus define a curved edge of the retaining member 58 in other embodiments.

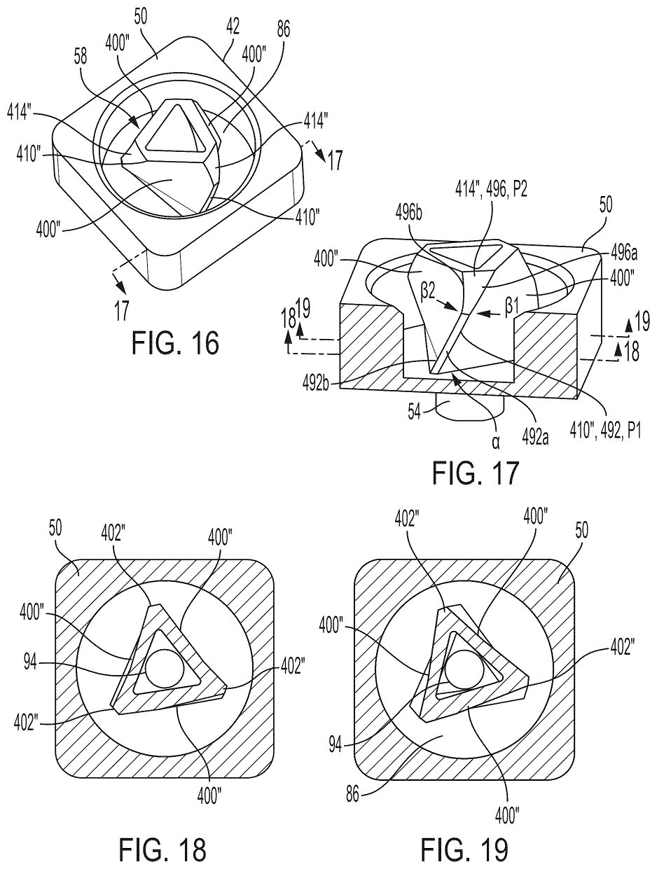

The embodiment of FIGS. 16-19 is variation of the embodiment of FIGS. 14-15. The retaining member 58 has three sides 400″ and has a generally triangular shape. The retaining member 58 surrounds the aperture 94 in the base 50. In the embodiment of FIGS. 16-19, each of the sides 400″ do not include separate portions. Instead, each of the sides 400″ extends from the bottom surface 86 toward the distal end 438′ of the retaining member 58 in a variety of planes. Each of the corners 402″ adjoining adjacent sides 400′ include a first portion 410″ and a second portion 414″. The first portion 410″ of each of the corners 402″ extends from the bottom surface 86 toward a distal end 438″ of the retaining member 58. The first portion 410″ of each of the corners 402″ defines a first face 492 having a forward edge 492a and a rearward edge 492b, which are each positioned at a non-perpendicular angle a relative to the bottom surface 86. Also, the first face 492 has a uniform width along its height, although in other embodiments, the width may not be uniform. The second portion 414′ of each of the corners 402″ extends from the first portion 410′ to the distal end 438′ of the retaining member 58. The second portion 414″ of each of the corners 402″ defines a second face 496 having a forward edge 496a extending from the forward edge 492a of the first face 492 and a rearward edge 496b extending from the rearward edge 492b of the first face 492. The forward edge 496a extends from the forward edge 492a at a first angle β1 and the rearward edge 496b extends from the rearward edge 492b at a second angle β2, which is different than the first angle β1. Accordingly, the second face 496 has variable width along its height, although in other embodiments, the width may be uniform.

As shown, collectively, the first faces 492 of the corners 402′ define the first portion 130 of the retaining member 58, while, collectively, the second faces 496 of the corners 402′ define the second portion 134 of the retaining member 58. Additionally, each of the first portions 410″ of the corners 402″ extends in a first plane P1 that is perpendicular to the bottom surface 86. Each of the second portions 414″ of the corners 402″ extends in a second plane P2 that is inwardly angled relative to the first portion 410″. The second portions 414″ are generally flat or planar in the illustrated embodiment and therefore, each define a chamfered edge.

Collectively, the second portions 414″ thus define a chamfered edge of the retaining member 58. In other embodiments, the second portions 414″ may be generally curved or arcuate and therefore, each define a radiused edge. Collectively, the second portions 414″ may thus define a curved edge of the retaining member 58 in other embodiments. Due to the variability in the faces 492, 496, the sides 400″ extending therebetween are also variable along the height of the retaining member 58. That is, in the embodiment of FIGS. 16-19, the triangular shape of the retaining member 58 has a “twisted” arrangement.

In the embodiment of FIGS. 12-13, the retaining member 58 is generally cylindrical and thus has a cross-section that is a circular shape. A plurality of projections 500 extends inwardly from an inner surface of the retaining member 58. The innermost ends of the projections 500 partially define the pathway for the fasteners. As shown, the retaining member 58 surrounds the aperture 94 in the base 50. The diameter of an inner perimeter defined by the inner surface of the retaining member 58 is greater than a diameter of the aperture 94 extending through the base 50.

As shown, the retaining member 58 includes a first portion 510 and a second portion 514. The first portion 510 extends from the bottom surface 86 toward a distal end 538 of the retaining member 58. The second portion 514 extends from the first portion 510 to the distal end 538 of the retaining member 58. As shown, the first portion 510 defines the first portion 130 of the retaining member 58, while the second portion 514 defines the second portion 134 of the retaining member 58. Additionally, the first portion 510 extends at a perpendicular angle relative to the bottom surface 86. In other embodiments, the first portion 510 may extend from the bottom surface 86 at a non-perpendicular angle. The second portion 514 is inwardly angled relative to the first portion 510. Moreover, a tangent at every point about the first portion 510 extends in a plane P1 that is perpendicular the bottom surface 86 and a tangent at every point about the second portion 514 extends in a plane P2 that is inwardly angled relative to the corresponding plane P1 of the first portion 510. The second portion 514 therefore defines a chamfered edge of the retaining member 58. In other embodiments, the second portion 514 may define a curved or radiused edge.

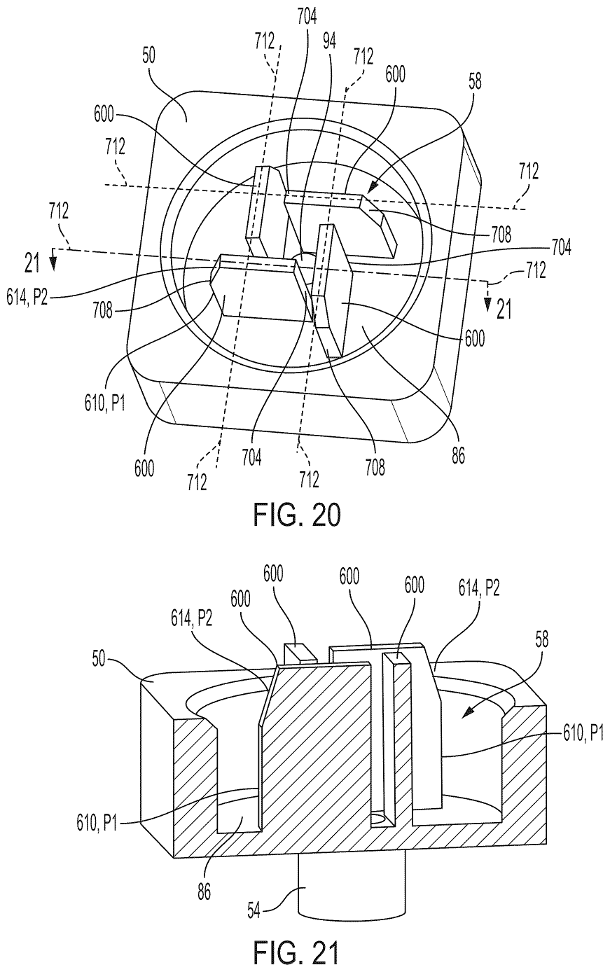

In the embodiment of FIGS. 20-21, the retaining member 58 includes a plurality of disconnected walls 600 positioned about the aperture 94. Each of the walls 600 includes a first end 704 positioned adjacent to the aperture 94, a second end 708 opposite the first end 704, and an axis 712 extending between the first end 704 and the second end 708. In the illustrated embodiment, the axes 712 of the walls 600 are positioned at perpendicular angles relative to the axes 712 of adjacent walls 600. In other embodiments, the axes 712 of the walls 600 may be positioned at non-perpendicular angles relative to the axes 712 of adjacent walls 600. Also, the first end 704 of each wall 600 is positioned between the first end 704 and the second end 708 of one adjacent wall and the second end 708 of each wall 600 extends beyond another adjacent wall 600.

As shown, each of the second ends 708 of the walls 600 include a first portion 610 and a second portion 614. The first portion 610 extends from the bottom surface 86 toward a distal end of the wall 600. The second portion 614 extends from the first portion 610 to the distal end 538 of the wall 600. As shown, collectively, each of the first portions 610 of the walls 600 define the first portion 130 of the retaining member 58, while, collectively, the second portions 514 of the walls 600 define the second portion 134 of the retaining member 58. Additionally, each of the first portions 610 extend at a perpendicular angle relative to the bottom surface 86. Each of the second portions 614 is inwardly angled relative to the respective first portion 510. Moreover, each of the first portions 510 extend in a plane P1 that is perpendicular the bottom surface 86 and each of the second portions 514 extend in a plane P2 that is inwardly angled relative to the corresponding plane P1 of the respective first portion 510. Each of the second portions 614 therefore define a chamfered edge of the retaining member 58. In other embodiments, each of the second portions 614 may define a radiused or curved edge instead.

Various features of the invention are set forth in the following claims.

1. A hanger accessory for use with a powered fastener driver, the powered fastener driver including a nosepiece from which fasteners are discharged, the hanger accessory comprising:
a bracket configured to be mounted to a work surface; and
an insert coupled to the bracket, the insert including
a base defining a recess having a bottom surface and an adjacent side wall, and
a retaining member extending from the bottom surface of the recess and spaced apart from the side wall, the retaining member having an aperture extending therethrough and defining an outer perimeter,
wherein the recess is configured to receive the nosepiece such that the outer perimeter of the retaining member is engaged by the nosepiece with an interference fit and with a distal end of the nosepiece contacting the bottom surface of the recess and an exterior of the nosepiece being spaced inward from the side wall.

2. The hanger accessory of claim 1, wherein the retaining member includes a first portion extending from the bottom surface and a second portion extending from the first portion, the first portion defining the outer perimeter and having a first width, the second portion having a second width that is smaller than the first width.

3. The hanger accessory of claim 2, wherein the first width is uniform along a length of the retaining member and wherein the second width decreases along the length of the retaining member.

4. The hanger accessory of claim 2, wherein the second portion defines a chamfered or a radiused edge of the retaining member.

5. The hanger accessory of claim 2, wherein the second portion is positioned at a non-parallel and non-perpendicular angle relative to the first portion.

6. The hanger accessory of claim 5, wherein the angle is greater than approximately 120 degrees and less than 180 degrees.

7. The hanger accessory of claim 2, wherein
the retaining member includes a shaft and a plurality of projections extending tangentially from the shaft, the shaft defining the aperture, each of the plurality of projections extending between the bottom surface of the recess and a distal end of the shaft,
a first portion of each of the plurality of projections extends from the bottom surface of the recess toward the distal end of the shaft, and a second portion of each of the plurality of projections extends from the first portion towards the distal end of the shaft, the second portion being tapered inwardly relative to the first portion,
collectively, the first portions of at least a subset of the plurality of projections define the first portion of the retaining member, and
collectively, the second portions of at least a subset of the plurality of projections define the second portion of the retaining member.

8. The hanger accessory of claim 2, wherein a height of the first portion is less than a height of the side wall of the recess.

9. The hanger accessory of claim 1, wherein the retaining member has a cross-section that is star-shaped, polygonal-shaped, or circular-shaped.

10. The hanger accessory of claim 1, wherein the base includes an outer wall and a plurality of notches in the outer wall.

11. The hanger accessory of claim 1, wherein the base includes an outer wall and a plurality of notches in the outer wall, each of the plurality of notches including a notch surface that is indented relative to the outer wall, and wherein the base further includes a plurality of grooves, each of the plurality of grooves extending between the side wall and a corresponding notch surface.

12. A hanger accessory for use with a powered fastener driver, the powered fastener driver including a nosepiece from which fasteners are discharged, the hanger accessory comprising:
a bracket configured to be mounted to a work surface; and
an insert supported by the bracket, the insert including
a base defining a recess defining a bottom surface and an adjacent side wall; and
a retaining member extending from the bottom surface of the recess and spaced apart from the side wall, the retaining member having an aperture extending therethrough, the retaining member having a distal end, a first portion extending from the bottom surface of the recess toward the distal end and defining an outer perimeter, a second portion extending from the first portion to the distal end, the second portion extending inwardly from the first portion at an angle, wherein the first portion has a height that is less than a height of the side wall,
wherein the recess is configured to receive the nosepiece such that the outer perimeter of the retaining member is engaged within the nosepiece with an interference fit.

13. The hanger accessory of claim 12, wherein the second portion defines a chamfered or a radiused edge of the retaining member.

14. The hanger accessory of claim 12, wherein the angle is greater than approximately 120 degrees and less than 180 degrees.

15. The hanger accessory of claim 12, wherein the retaining member has a cross-section that is star-shaped, polygonal-shaped, or circular-shaped.

16. The hanger accessory of claim 12, wherein
the retaining member includes a shaft and a plurality of projections extending tangentially from the shaft, the shaft defining the distal end and the aperture, each of the plurality of projections extending between the bottom surface of the recess and toward the distal end,
a first portion of each of the plurality of projections extends from the bottom surface of the recess toward the distal end and a second portion of each of the plurality of projections extends from the corresponding first portion to toward distal end of the shaft, the second portion of each of the plurality of projections being tapered inwardly relative to the corresponding first portion,
collectively, the first portions of at least a subset of the plurality of projections define the first portion of the retaining member, and
collectively, the second portions of the at least a subset of the plurality of projections define the second portion of the retaining member.

17. The hanger accessory of claim 12, wherein the recess is configured to receive the nosepiece such that a distal end of the nosepiece contacts the bottom surface of the recess and an exterior of the nosepiece is spaced inward from the side wall.

18. A hanger accessory for use with a powered fastener driver, the powered fastener driver including a nosepiece from which fasteners are discharged, the hanger accessory comprising:
a bracket configured to be mounted to a work surface; and
an insert supported by the bracket, the insert including
a base defining a recess defining a bottom surface and an adjacent side wall; and
a retaining member extending from the bottom surface of the recess and spaced apart from the side wall of the recess, the retaining member including
a shaft extending from the bottom surface and having a distal end opposite the bottom surface and an aperture extending along a length of the shaft, and
a plurality of projections extending tangentially from the shaft, each of the plurality of projections extending between the bottom surface of the recess to the distal end,
wherein a first portion of each of plurality of projections extends from the bottom surface of the recess toward the distal end and a second portion of each of the plurality of projections is extending inwardly relative to the corresponding first portion,
wherein the recess is configured to receive the nosepiece such that the first portions of at least a subset of the plurality of projections are collectively engaged by the nosepiece with an interference fit and with a distal end of the nosepiece contacting the bottom surface of the recess and an exterior of the nosepiece being spaced inward from the side wall.

19. The hanger accessory of claim 18, wherein the subset of the projections that is a first subset of the projections and further comprising a second subset of the projections, each projection of the first subset having a first length and each projection of the second subset having a second length that is shorter than the first length.

20. The hanger accessory of claim 19, wherein the first subset of the projections defines a first diameter that is greater than a second diameter defined by the second subset of the projections.

21. The hanger accessory of claim 18, wherein the second portion of each of the plurality of projections is positioned at a non-parallel and non-perpendicular angle relative to the corresponding first portion.

22. The hanger accessory of claim 18, wherein the second portion of each of the projections is positioned at an angle that is greater than approximately 120 degrees and less than 180 degrees.

23. The hanger accessory of claim 18, wherein a height of the first portion is less than a height of the side wall of the recess.

24.-33. (canceled)
